(19) United States
(12) Patent Application Publication
(10) Pub. No.: US 2026/0116076 A1
(43) Pub. Date: Apr. 30, 2026

(54) Ink Reservoir, as Well as Device and Method for Operating a Printing Device Having an Ink Reservoir

(71) Applicant: Canon Production Printing Holding B. V., Venlo (NL)

(72) Inventors: Florian Hitzlsperger, Poing (DE); Ulrich Stöckle, Germering (DE); Claus Schneider, Eching (DE)

(21) Appl. No.: 19/374,437

(22) Filed: Oct. 30, 2025

(30) Foreign Application Priority Data
Oct. 30, 2024 (DE) 10 2024 131 693.4

(51) Int. Cl. B41J 2/175

(52) U.S. Cl. CPC B41J 2/17546; B41J 2/17513; B41J 2/17523; B41J 2/17553; B41J 2/17596; B41J 2002/17516

(57) ABSTRACT

An ink reservoir to hold ink for an inkjet printing device is described. The ink reservoir has an extraction opening that is designed for connection of a conduit for the extraction of ink from the ink reservoir. The ink reservoir has a machine-readable code. The ink reservoir is designed such that the code is damaged if the extraction opening is accessed in order to be able to connect a conduit to the extraction opening, and/or if a conduit is connected to the extraction opening.

### CROSS-REFERENCE TO RELATED APPLICATION

This application claims priority to German Patent Application No. 10 2024 131 693.4 filed Oct. 30, 2024, the disclosure of which is hereby incorporated by reference in its entirety.

### BACKGROUND OF THE INVENTION

### Field of the Invention

The invention relates to an ink reservoir for providing ink for an inkjet printing device, as well as a control device and a corresponding method for operating an inkjet printing device having an ink reservoir.

### Description of Related Art

An inkjet printing device for printing to a recording medium can comprise a print bar having one or more print heads with respectively one or more nozzles. The nozzles are respectively configured to eject ink droplets in order to print dots of a print image onto the recording medium. The individual print heads of a print bar are supplied with ink by an ink supply system, wherein the ink supply system typically has an ink reservoir from which ink is provided for the operation of the inkjet printing device. The ink reservoir can possibly be manipulated in an unauthorized manner, for instance with an ink that is unsuitable for the printing device, whereby the print quality of the inkjet printing device can be negatively affected.

### SUMMARY OF THE INVENTION

The present document deals with the technical object of effecting an efficient and reliable protection of an ink reservoir against manipulation, in particular in order to ensure a high print quality of an inkjet printing device in the long term. The object is respectively achieved by the features described herein.

According to one aspect, an ink reservoir is described for holding ink for an inkjet printing device. The ink reservoir has an extraction opening that is designed for connection of a conduit for the extraction of ink from the ink reservoir. Furthermore, the ink reservoir has a machine-readable code. The ink reservoir is designed such that the code is damaged, in particular must be damaged, if the extraction opening is accessed in order to be able to connect a conduit to said extraction opening, and/or if a conduit is connected to the extraction opening.

According to a further aspect, a device is described for operating an inkjet printing device having an ink reservoir. The device is configured to detect that a conduit of the ink supply system of the inkjet printing device has been connected to the extraction opening of the ink reservoir. The device is also configured to operate, in reaction to the detection of the inkjet printing device, depending on whether or not the code of the ink reservoir has been registered, in particular before the connection of the conduit to the extraction opening.

According to a further aspect, a method is described for operating an inkjet printing device having an ink reservoir. The method comprises detecting that a conduit of an ink supply system of the inkjet printing device has been connected to the extraction opening of the ink reservoir. Furthermore, the method comprises operating the inkjet printing device depending on whether or not the code of the ink reservoir has been registered, in particular chronologically before the connection of the conduit to the extraction opening.

### BRIEF DESCRIPTION OF THE DRAWINGS

In the following, exemplary embodiments of the invention are described in detail using the schematic drawings. Thereby shown are:

FIG. 1 a block diagram of an example of an inkjet printing device;

FIG. 2 an example of an ink supply system for a print bar of an inkjet printing device;

FIG. 3a an example of an ink reservoir in a front view;

FIG. 3b an example of an ink reservoir in a side view; and

FIG. 4 a workflow diagram of an example of a method for operating a printing device having an ink reservoir.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

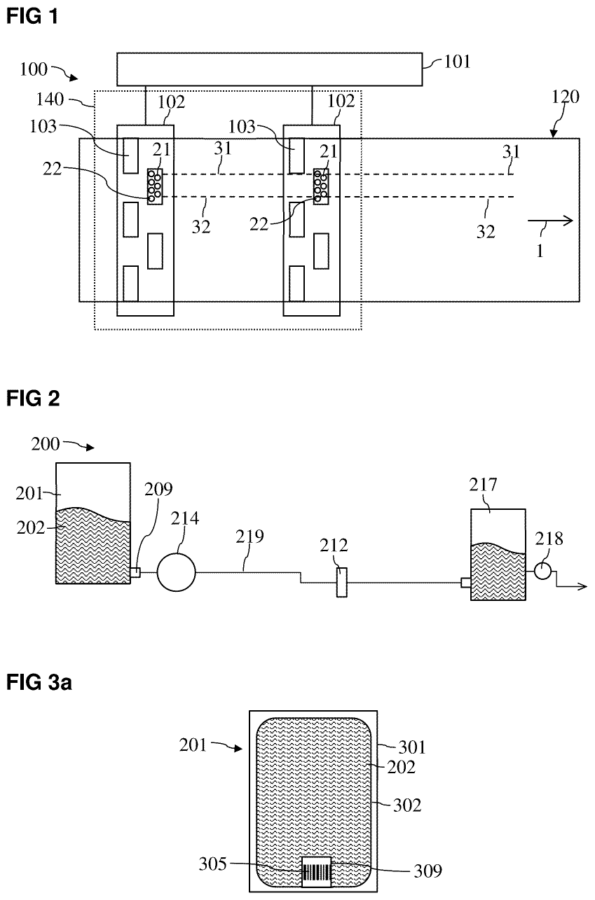

The printing device 100 depicted in FIG. 1 is designed for printing to a recording medium 120 in the form of a sheet or page or plate or belt. The recording medium 120 can be produced from paper, paperboard, cardboard, metal, plastic, textiles, a combination thereof, and/or other materials that are suitable and can be printed to. The recording medium 120 is guided through the print group 140 of the printing device 100 along the transport direction 1, represented by an arrow.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the printing device 100 typically comprises at least one fixing or drying unit that is not shown in FIG. 1 and that is configured to fix a print image printed onto the recording medium 120.

A print bar 102 can comprise one or more print heads 103 that are possibly arranged side by side in a plurality of rows in order to print the dots of different columns 31, 32 of a print image onto the recording medium 120. In the example presented in FIG. 1, a print bar 102 comprises five print heads 103, wherein each print head 103 prints the dots of a group of columns 31, 32 of a print image onto the recording medium 120. The number of print heads 103 of a print bar 102 can, for example, be 5, 10, or more.

In the embodiment depicted in FIG. 1, each print head 103 of the print group 140 comprises a plurality of nozzles 21, 22, wherein each nozzle 21, 22 is configured to fire or eject ink droplets onto the recording medium 120. For example, a print head 103 of the print group 140 can comprise multiple thousands of effectively utilized nozzles 21, 22 that are arranged along multiple rows transverse to the transport direction 1 of the recording medium 120. Dots of a line of a print image can be printed onto the recording medium 120 transverse to the transport direction 1, i.e. along the width of the recording medium 120, by means of the nozzles 21, 22 of a print head 103 of the print group 140.

The printing device 100 also comprises a control device 101, for example a driving hardware and/or a controller, that is configured to drive the actuators of the individual nozzles 21, 22 of the individual print heads 103 of the print group 140 in order to apply the print image onto the recording medium 120 depending on print data. In an exemplary embodiment, the control device 101 includes processing circuitry or at least one processor that is configured to perform one or more functions and/or operations of the control device 101, including activating the actuators of the individual nozzles 21, 22 of the individual print heads 103 of the print group 140 to apply the print image onto the recording medium 120 based on print data, processing print and/or other data, control one or more modes of the printing device 100 and/or controlling one or more operations of the printing device 100. In an exemplary embodiment, the control device 101 includes one or more interfaces (e.g. a wired and/or wireless input and/or output interface, transceiver, or the like) that are configured to receive or output data or information. For example, the control device 101 may receive signals generated by one or more components of the printing device 100 (e.g. from a user interface of the printing device 100) and/or output control signals to one or more components of the printing device 100. In an exemplary embodiment, the control device 101 includes a memory configured to store data/information, and/or store executable code that is executable by the processing circuitry to cause the processing circuitry or at least one processor to perform the operation(s) of the control device 101.

The print group 140 of the printing device 100 thus comprises at least one print bar 102 having K nozzles 21, 22 that can be arranged in one or more print heads 103 and that can be driven with a defined line timing in order to print a respective line with K pixels or K columns 31, 32 of a print image into the recording medium 120, for example with K>1000, said line running transverse to the transport direction 1 of said recording medium 120. In the shown example, the nozzles 21, 22 are installed immobile or fixed in the printing device 100, and the recording medium 120 is directed past the stationary nozzles 21, 22 with a defined transport velocity.

FIG. 2 shows an example of an ink supply system 200 that is designed to supply one or more print heads 103 of a print bar 102 of the printing device 100 with ink 202. The ink supply system 200 comprises an ink reservoir 201 that is designed to store ink 202. For example, the ink reservoir 201 can be designed to store and/or to hold 100 liters or more of ink 202. The ink 202 can be conducted out of the ink reservoir 201 via an extraction opening 209 that, for example, is arranged at the floor of the ink reservoir 201. For this purpose, a conduit 219 can be connected to the extraction opening 209 of the ink reservoir 201. A pump 214 that is designed to pump ink 202 out of the ink reservoir 201 may also be arranged at the conduit 219.

The ink 202 extracted from the ink reservoir 201 can be conducted via the conduit 219 to an intermediate container 217 217, wherein the ink 202 can be pumped from the intermediate container 217 to the one or more print heads 103 of the print bar 102 using an additional pump 218. A filter unit 212 can be arranged at the conduit 219, which filter unit 212 is designed to filter the ink 202 extracted from the ink reservoir 201 in order to filter contaminants and/or sediments out of said ink 202. It can thus be reliably avoided that the nozzles 21, 22 of the one or more print heads 103 of the print bar 102 clog due to contaminated ink 202.

The ink 202 provided in the ink reservoir 201 can have one or more properties that are matched to the one or more print heads 103 of the print bar 102 in order to ensure a high print quality of the print bar 102. Examples of properties are the chemical composition of the ink 202, the viscosity of the ink 202, and/or the drying speed of the ink 202.

The ink reservoir 201 can be designed such that a manipulation of the ink reservoir 201 can be efficiently and reliably avoided and/or prevented, in particular with regard to the ink 202 stored in the ink reservoir 201. The ink reservoir 201 can in particular be designed such that
the ink reservoir 201 can be used only a single time with the original ink 202; and/or
the ink reservoir 201 cannot be used repeatedly, for example with refilled ink 202.

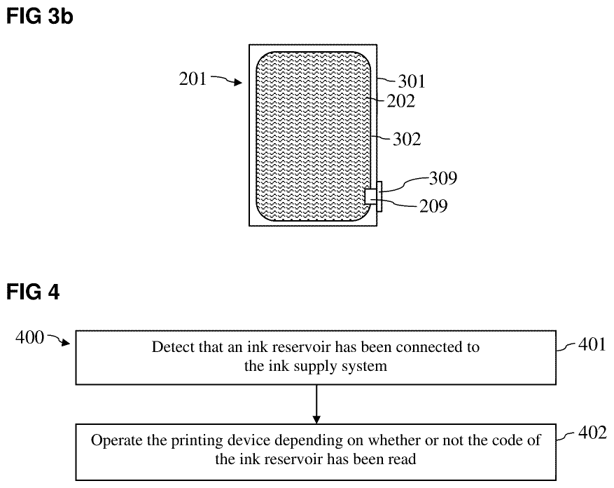

FIG. 3a shows an example of an ink reservoir 201 in a front view toward the front of the ink reservoir 201, at which is arranged the extraction opening 209 for extraction of ink 202. FIG. 3b shows the exemplary ink reservoir 201 in a side view.

The ink reservoir 201 can have an outer enclosure 301 that encloses an inner enclosure 302 of the ink reservoir 201. The inner enclosure 302 can be designed as a container, in particular a closed container, to hold ink 202. The inner enclosure 302 can, for example, be formed by a flexible bag, wherein the bag is comprised of plastic, for example. The use of a flexible inner enclosure 302 enables the ink 202 to be stored essentially without ingress of air, whereby a negative effect on the ink 202 during storage over a relatively long storage time period can be avoided, or at least reduced. The flexible inner enclosure 302 can also contract upon extraction of ink 202, so that the ink 202 can be reliably extracted, in particular pumped, completely out of the inner enclosure 302.

The extraction opening 209 is preferably arranged directly at the inner enclosure 302. The extraction opening 209 can, for example, have a valve that can be opened for the extraction of ink 202 and that can be closed as needed in order to prevent the extraction of ink 202. Furthermore, the extraction opening 209 can have a coupling that is designed to be connected with a complementary coupling of the conduit 219 in order to connect said conduit 219 in a fluid-conducting manner to the ink reservoir 201, in particular to the inner enclosure 302 of the ink reservoir 201. The extraction opening 209 can in particular be designed as a hose coupling, possibly with valve.

The (in particular flexible) inner enclosure 302 can be arranged in a preferably rigid outer enclosure 301 of the ink reservoir 201. The outer enclosure 301 can form a support structure for the inner enclosure 302. In particular, via the outer enclosure 301 it can be effected that the ink reservoir 201 can be set down in a stable manner, for example on a table or on a floor. The outer enclosure 301 can, for example, be designed as a preferably cubic carton, in particular a cardboard box. The ink reservoir 201 can, for example, be designed as what is known as a “Bag-in-Box.”

A covering 309 can be arranged at the outer enclosure 301 of the ink reservoir 201, which covering is designed to cover the extraction opening 209 for extraction of ink 202. The covering 309 is preferably designed such that it is necessary that a user remove, and preferably destroy, the covering 309 in order to gain access to the extraction opening 209. For example, it can be necessary that the user removes or drills through the covering 309 in order to gain access to the extraction opening 209.

A code 305, in particular a machine-readable code, for instance a barcode or a QR (Quick Response) code, can be arranged on the covering 309 of the extraction opening 209. The code 305 is thereby preferably designed such that it is necessary that the user destroy the code 305, possibly together with the covering 309, in order to gain access to the extraction opening 309. It can thus be achieved that the code 305 can no longer be read, in particular can no longer be read and/or scanned automatically by a reading device, after access to the extraction opening 209 has been gained and/or after the ink reservoir 201 has been connected via the extraction opening 209 to the conduit 219 of the ink supply system 200. It can thus be ensured that the code 305 can be read, in particular be read automatically, only as long as access to the extraction opening 209 has not been gained and/or as long as no conduit 219 has been connected to the extraction opening 209.

A code 305, in particular a QR code, can be printed on a perforated covering 309, for example on a perforated label, over the extraction opening 209 of an ink reservoir 201, wherein the covering 309 must be removed so that the conduit 219 of the ink supply system 200 can be connected to the ink reservoir 201.

The code 305 on the covering 309 of an ink reservoir 201 can specify an identifier of the ink 202 that is contained in the ink reservoir 201. The code 305 can be read in by a reading device of the printing device 100 and/or of the ink supply system 200. The ink supply system 200 of the printing device 100 can have a compartment for the ink reservoir 201. The reading device for the code 305 can be arranged at the compartment for the ink reservoir 201.

The (control) device 101 of the ink supply system 200 and/or of the printing device 100 can be configured to check, on the basis of the read-in code 305 of the ink reservoir 201, in particular on the basis of the identifier of the ink 202, whether an ink reservoir 201 with the correct ink 202, in particular with the correct ink color, has been arranged at the compartment of the ink supply system 200. Furthermore, the device 101 can be configured to output an error message and/or to prevent the operation of the printing device 100
if it is recognized that the wrong ink 202 is contained in the ink reservoir 201; and/or
if, in particular as long as, no code 305 of the ink reservoir 201 arranged at the compartment of the ink supply system 200 has been read.

The device 101 can be configured to enable the operation of the printing device 100 when, possibly only when,
a code 305 of the ink reservoir 201 arranged at the compartment of the ink supply system 200 has been read in, in particular only when the code 305 has already been read in before connection of the ink reservoir 201 to the conduit 219 of the ink supply system 200; and/or
the code 305 indicates that the correct ink 202 is contained in the ink reservoir 201.

A high print quality of the printing device 100 can thus be ensured.

A code, in particular a QR code, can possibly be arranged at the compartment for an ink reservoir 201, which code indicates information with regard to the ink 202 that should be contained in an ink reservoir 201 that is placed in this compartment. The device 101 can be configured to also check, on the basis of the code at the compartment, whether the correct ink 202 is contained in the ink reservoir 201 placed in the compartment.

As has already been presented, the ink reservoir 201 is preferably designed such that, after the code 305 of the ink reservoir 201 has been scanned, the code 305 and/or the covering 209 must be damaged and/or destroyed in order to gain access to the extraction opening 209 of the ink reservoir 201, and/or in order to connect the ink reservoir 201 to the conduit 219. It is thereby prevented that the code 305 can be re-scanned, for example in order to use the ink reservoir 201 an additional time with refilled, possibly unsuitable ink 202. A manipulation of an ink reservoir 201, for example for a repeated usage with refilled ink, can thus be efficiently and reliably prevented. A reliable protection of the extraction opening 209, in particular of the coupling, of the ink reservoir 201 can thus also be provided, since the extraction opening 209 is typically accessible only when the ink reservoir 201 is arranged at the compartment of the ink supply system 200.

FIG. 4 shows a workflow diagram of a method 400 (possibly a computer-implemented method 400) for operation of an inkjet printing device 100 having an ink reservoir 201. The ink reservoir 201 can be designed as described in this document. In particular, the ink reservoir 201 can comprise ink 202 that can be extracted from the ink reservoir 201, in particular from the inner enclosure 302 of the ink reservoir 201, via an extraction opening 209. Furthermore, the ink reservoir 201 can have a code 305, in particular a QR code. The code 305 can specify information with regard to the ink 202 contained in the ink reservoir 201, for example the color, type, and/or manufacturer. The code 305 can be designed such that said code 305 can be registered, for example scanned, by a reading device of the printing device 100 in order to determine the information indicated by the code 305 with regard to the ink 202.

The method 400 comprises the detection 401 that a conduit 219 of the ink supply system 200 of the inkjet printing device 100 has been connected to the extraction opening 209 of the ink reservoir 201 (in order to extract ink 202 from the ink reservoir 201 for the operation of the printing device 100). For example, this can be recognized on the basis of sensor data of a sensor (for example a pressure sensor) of the ink supply system 200.

Furthermore, the method 400 comprises the operation 402 of the inkjet printing device 100 depending on whether or not the code 305 of the ink reservoir 201 has been registered. In particular, the operation of the printing device 100 can be enabled or prevented depending on whether or not the code 305 of the ink reservoir 201 has been registered. The operation of the printing device 100 can be prevented if the code 305 has not been registered, or if the code 305 was not registered before the connection of the conduit 219 to the extraction opening 209 of the ink reservoir 201. On the other hand, the operation of the printing device 100 can be enabled if the code 305 was registered. If applicable, the operation of the printing device 100 can be enabled only when the code 305 was registered before the connection of the conduit 219 to the extraction opening 209 of the ink reservoir 201 was detected. The operation of the printing device 100 with a manipulated ink reservoir 201 can thus be efficiently and reliably avoided, whereby a high print quality of the printing device 100 can be ensured in the long term.

In this document, an ink reservoir 201 is thus described for holding ink 202 for an inkjet printing device 100, in particular for the operation of an inkjet printing device 100. The ink reservoir 201 can be designed to be placed in a compartment of the ink supply system 200 of the printing device 100. The ink reservoir 201 can have an inner enclosure 302 to hold the ink 202. The inner enclosure 302 can be flexible. Alternatively or additionally, the inner enclosure 302 can be comprised of a flexible material, in particular plastic. Furthermore, the ink reservoir 201 can have an outer enclosure 301 that encloses, preferably entirely encloses, the inner enclosure 302. The outer enclosure 301 can be designed as a support structure for the inner enclosure 302. Alternatively or additionally, the outer enclosure 301 can be comprised of a rigid material, in particular of cardboard.

The ink reservoir 201 has an extraction opening 209 that is designed for connection to a conduit 219 for the extraction of ink 202 from the ink reservoir 201. The extraction opening 209 can be arranged at the inner enclosure 302, in particular such that the extraction opening 209 is covered by the outer enclosure 301, and/or such that the access to the extraction opening 209 is obstructed by the outer enclosure 301. In the unopened state of the ink reservoir 201, the access to the extraction opening 209 can thus be obstructed or blocked, for example by the outer enclosure 301.

The extraction opening 209 can comprise a coupling, in particular a hose coupling, that is designed to be plugged together with a complementary coupling of a conduit 219 of the ink supply system 200 of the printing device 100. Alternatively or additionally, the extraction opening 209 can comprise a valve. The extraction opening 209 can thereby be designed such that the valve is opened automatically if a conduit 219 is connected to the extraction opening 209 in order to extract ink 202 from the ink reservoir 200, in particular from the inner enclosure 302 of the ink reservoir 200, and supply said ink 202 to a print bar 102 of the printing device 100.

The ink reservoir 201 has a machine-readable code 305. The code 305 can be arranged on the outer enclosure 301 of the ink reservoir 201 so that the code 305 is externally visible. The ink reservoir 201 can have a covering 309, for example as part of the outer enclosure 301, that covers the extraction opening 209 and/or that obstructs access to the extraction opening 209. The covering 309 can thus be arranged at the outer enclosure 301. The covering 209 can, for example, be designed as a perforated partial region of the outer enclosure 301. The code 305 can be arranged on the covering 309.

The code 305 can specify information with regard to the ink 202 contained in the ink reservoir 201, for example the color of the ink 202, the manufacturer of the ink 202, the type of the ink 202 from a list of different ink types, and/or a use-by date or a manufacturing date of the ink 202. The code 305 can comprise or be a QR code, for example.

The ink reservoir 201 is designed such that the code 305 is damaged, in particular must be damaged, if
the extraction opening 209 is accessed in order to be able to connect a conduit 219 to the extraction opening 209; and/or
a conduit 219 is connected to the extraction opening 209.

Alternatively or additionally, the ink reservoir 201 is designed such that the covering 209 with the code 305 is damaged or removed, in particular must be damaged or removed, in order
to access the extraction opening 209; and/or
to connect a conduit 219 to the extraction opening 209.

Via the described ink reservoir 201, it can be efficiently and reliably avoided that the ink reservoir 201 is manipulated and possibly filled with unsuitable ink and used repeatedly. A high print quality of the printing device 100 can thus be ensured in the long term.

Furthermore, in this document a (control) device 101 is described for operating an inkjet printing device 100 having an ink reservoir 201. The ink reservoir 201 can be designed as described in this document. The device 101 can be part of the printing device 100.

The device 101 is configured to detect that a conduit 219 of the ink supply system 200 of the inkjet printing device 100 has been connected to the extraction opening 209 of the ink reservoir 201, in particular in order to extract ink 202 from the ink reservoir 201.

Furthermore, in reaction to the detection, the device 101 can be configured to operate the inkjet printing device 100 depending on whether or not the code 305 of the ink reservoir 201 was registered by a reading device of the printing device 100, in particular before the connection of the conduit 219 to the ink reservoir 201.

The device 101 can be configured to prevent the extraction of ink 202 from the ink reservoir 201, and/or the operation of the inkjet printing device 100, if the code 305 of the ink reservoir 201 has not been registered, in particular was not registered before the connection of the conduit 219 to the extraction opening 209. Alternatively or additionally, the device 101 can be configured to enable the extraction of ink 202 from the ink reservoir 201 and/or the operation of the inkjet printing device 100 only when the code 305 of the ink reservoir 201 has been registered beforehand, in particular before the connection of the conduit 219 to the extraction opening 209. Alternatively or additionally, the device 101 can be configured to output a notification, for example in the form of an error message, via the user interface of the inkjet printing device 100, if the code 305 of the ink reservoir 201 has not been registered, in particular was not registered before the connection of the conduit 219 to the extraction opening 209.

It can thus be efficiently and reliably ensured that the ink reservoir 201 is not filled, for example with impermissible ink 202, and used repeatedly. As a result of this, a high print quality of the printing device 100 can be ensured in the long term.

Moreover, in this document a printing device 100 is described that comprises the device 101 described in this document.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the terms “processing circuitry” and “control device” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 transport direction (of the recording medium)
21, 22 nozzle
31, 32 column (of the print image)
100 printing device
101 (control) device
102 print bar
103 print head
120 recording medium
140 print group
200 ink supply system
201 reservoir
202 ink
209 extraction opening (coupling)
212 filter unit
214 pump
217 intermediate container
218 pump
219 conduit
301 outer enclosure
302 inner enclosure
305 code
309 covering
400 method for operating a printing device having an ink reservoir
401-402 method steps

1. An ink reservoir to hold ink for an inkjet printing device, the ink reservoir comprising:
an extraction opening configured for connection of a conduit for the extraction of ink from the ink reservoir; and
a machine-readable code, wherein
the ink reservoir is configured such that the code is damaged if at least one of
the extraction opening is accessed in order to be able to connect a conduit) to the extraction opening; or
a conduit is connected to the extraction opening.

2. The ink reservoir according to claim 1, further comprising
a covering that at least one of covers the extraction opening or obstructs access to the extraction opening,
wherein the code is arranged on the covering; and
wherein the ink reservoir is configured such that the covering must be damaged or removed in order to at least one of
access the extraction opening; or
connect a conduit to the extraction opening.

3. The ink reservoir according to claim 2, further comprising
an inner enclosure to hold the ink, wherein the extraction opening is arranged at the inner enclosure; and
an outer enclosure that encloses the inner enclosure, wherein the covering is arranged at the outer enclosure.

4. The ink reservoir according to claim 3, wherein
the inner enclosure is comprised of a flexible material; and/or
the outer enclosure is designed as a support structure for the inner enclosure.

5. The ink reservoir according to claim 4, wherein the outer enclosure is comprised of a rigid material.

6. The ink reservoir according to claim 1, wherein
the code specifies information with regard to the ink contained in the ink reservoir; and/or
the code comprises a QR code.

7. The ink reservoir according to claim 1, wherein the extraction opening comprises a coupling configured to be plugged together with a complementary coupling of a conduit.

8. The ink reservoir according to claim 1, wherein
the extraction opening comprises a valve; and
the extraction opening is configured such that the valve is opened automatically if a conduit is connected to the extraction opening.

9. A device for operation of an inkjet printing device having an ink reservoir accordingly to claim 1, the device comprising at least one processor configured:
to detect that the conduit of an ink supply system of the inkjet printing device has been connected to the extraction opening of the ink reservoir; and
to operate the inkjet printing device depending on whether or not the code of the ink reservoir has been registered.

10. The device according to claim 8, wherein the at least one processor is further configured:
to prevent the extraction of ink from the ink reservoir, and/or the operation of the inkjet printing device, if the code of the ink reservoir has not been registered.

11. The device according to claim 8, wherein the at least one processor is further configured:
to enable the extraction of ink from the ink reservoir, and/or the operation of the inkjet printing device, only when the code of the ink reservoir has been registered beforehand.

12. The device according to claim 8, wherein the at least one processor is further configured:
to output a notification, via a user interface of the inkjet printing device, if the code of the ink reservoir has not been registered.

13. A method for operating an inkjet printing device with an ink reservoir according to claim 1, the method comprising
detecting that the conduit of an ink supply system of the inkjet printing device has been connected to the extraction opening of the ink reservoir; and
operating the inkjet printing device depending on whether or not the code of the ink reservoir has been registered.
